(19) United States
(12) Patent Application Publication
(10) Pub. No.: US 2010/0189813 A1
(43) Pub. Date: Jul. 29, 2010

(54) Cidal formulations and methods of use

(76) Inventors: Venkat Hari, Oakland, MI (US); D. Carl Freeman, Troy, MI (US)

Correspondence Address: MCKELLAR IP LAW, PLLC, 784 SOUTH POSEYVILLE ROAD, MIDLAND, MI, 48640, US

(21) Appl. No.: 12/660,296

(22) Filed: Feb. 24, 2010

Related U.S. Application Data
(62) Division of application No. 11/715,114, filed on Mar. 7, 2007.
(60) Provisional application No. 60/780,906, filed on Mar. 9, 2006.

(51) Int. Cl. A01N 59/20

(52) U.S. Cl. 424/637

(57) ABSTRACT

Formulated Cidal compositions containing a metal compound, an inert carrier for the metal compound and, a detergent, wherein the metal and the detergent are present at low concentrations and methods of using Cidal compositions in aqueous environments.

This application claims priority from US Utility Patent Application No.

11/715,114 filed Mar. 7, 2007 and U.S. Provisional Patent Application No. 60/780,906 filed Mar. 9, 2006.

This invention deals with, in one embodiment, a combination of a metal compound, a detergent and an inert carrier as a Formulated Cidal composition, and in another embodiment as an Unformulated Cidal composition comprising a metal compound in an inert carrier, wherein it is contemplated that such Cidal compositions are useful in very low concentrations that create very low concentrations of the metal, as ovicides, larvicides, pupicides, insecticides, biological control agents, pathogenocides, parasiticides, microbial control agents, insect growth regulators, conventional toxicants, pesticides, in aqueous environments and as fungal control agents, viral control agents, mold control agents, or other such pests on various solid substrates. The instant invention also relates to methods of use of the Formulated and Unformulated Cidal compositions.

Combinations of two or more metal compounds or two or more detergents and combinations of two or more metal compounds and two or more detergents are also contemplated in this invention.

By “Cidal” as used herein, it is meant that the Formulated and Unformulated compositions have the capability of killing or controlling the various pests, fungi, molds, bacteria, viruses, etc., eluded to just Supra.

By “Pests” as used herein, it is meant insects, pathogens, parasites, microbes, fungi, molds, viruses, and the like, and their contaminates, such as eggs, larvae, pupae, and the like.

By the use of the term “Effigy” herein, it is meant an amount effective to control or kill Pests as the term is conventionally used by those skilled in the art.

The term “Formulated” as used herein means any composition containing at least one metal compound, a carrier for the metal compound, and at least one detergent as set forth in this specification and claims.

The term “Unformulated” as used herein means any composition containing a metal compound and an inert carrier as used in this specification and is used to distinguish the non-detergent containing compositions from the detergent containing compositions.

Specifically, the methods of application include applying the Cidal composition to an aquatic environment having a natural population of aquatic environmental Pests, for the purpose of controlling that population of Pests. Further, the instant invention also relates to the use of the Cidal delivery compositions for a pretreatment application to an aquatic Pest dry habitat in order to control that population of aquatic Pests that will otherwise breed when the instant habitat becomes flooded by rain, or the like.

The instant invention also contemplates the use of a combination of Formulated Cidal compositions in the alluded-to methods of application.

Further, it is contemplated within the scope of this invention to treat aquatic environments for the purposes of preventing breeding of various insects, especially mosquitoes.

It is especially contemplated within the scope of this invention to control the immature aquatic stages of various species of various insects before they become adults capable of being a nuisance and/or capable of transmitting diseases.

In addition, to mosquitoes, other species of aquatic environment insects such as biting and non-biting midges, black flies, moth flies, crane flies, horse flies, deer flies, hover or flower flies, can be treated. Such insects can constitute a nuisance and often are a health threat to humans and livestock.

In addition, it is contemplated within the scope of this invention to apply the Formulated compositions to solid substrates, for example, to kill or control molds, bacteria, fungi, viruses, and the like.

It is a major benefit of this invention to use the Cidal compositions in very low amounts yet have them be effective at the low concentrations to kill or control Pests, such that such compositions can be used in drinking water applications.

### BACKGROUND OF THE INVENTION

National Geograph News, in reporting on the “The Africa Malaria Report”, has stated that “Malaria kills more than a million people worldwide each year, 90 percent of them in Africa; 70 percent children under the age of five.” Malaria, the report noted, is the single biggest killer of children under five and a serious threat to pregnant women and their newborn.” The report stated: “New analyses confirm that malaria is a principal cause of at least one-fifth of all young child deaths in Africa and no country in Africa south of the Sahara for which data are available shows a substantial decline.”

The WHO-UNICEF report also describes malaria as “a brake on development.” The World Bank, which contributed a chapter to the report, estimates that malaria costs Africa more than U.S. $12 billion annually and has slowed economic growth in African countries by 1.3 percent a year. Sub-Saharan Africa's GDP is 32 percent lower than it would have been by now had malaria been eradicated in 1960, the World Bank states.”

In response to this information the inventors herein have discovered and developed a Formulated Cidal composition that allows metal in a highly diluted form (in the form of the metal) to be used to control mosquito larval at doses well within the EPA drinking water limit of 1.3 parts per million. The product has been demonstrated to kill Aedes, Culex and Anopheles mosquitoes at those concentrations. In another embodiment, Unformulated compositions can be used at doses of 1.3 parts per million to control and kill Pests.

Cidal compositions and methods for controlling and killing insects are well known. A number of patents discuss the use of Pesticides or insecticides. For Example, U.S. Pat. No. 5,690,950, issued on Nov. 25, 1997 deals with a composition and method for killing insect larvae. The composition consists of one or more C₂ to C₆ aliphatic carboxylic acids or alkali metal, alkaline earth, ammonia, primary, secondary, tertiary, or quaternary ammonium salts in an acceptable formulation for larvicides. The composition is applied in aqueous or organic solvents.

Another patent is U.S. Pat. No. 5,314,699 that issued on May 24, 1994 to Baden in which there is disclosed compositions and methods for controlling fleas and flea larvae using boron-containing compounds impregnated into a substrate such as a carpet.

Still further is U.S. Pat. No. 5,643,971, that issued Jul. 1, 1997 to Roenigk that discloses a metal complex capable of being dispersed in or alternatively formed in a water absorbing article. The metal complex consists of one or more metal ions, at least one chelating polymer chelated to the transition metal ion and at least one potentiator chelated to the transition metal ion.

Also see U.S. Pat. No. 3,535,423 that issued Oct. 20, 1970 in which there is disclosed a wettable powder Pesticide concentrate that may be dispersed in water. This is described as allowing the otherwise insoluble Pesticide to become soluble in water.

In addition, U.S. Pat. No. 4,267,280, issued on May 12, 1981 discloses controlled release Pesticides and their preparation. These Pesticides are described as polymers with a macromolecular backbone and pendant groups having Cidal groups chemically linked thereto and they are prepared by reacting a Pesticide having a labile hydrogen, with a multi-functional isocyanate, to form an adduct which is then reacted with a polyol polymer substrate.

Further, U.S. Pat. Nos. 4,400,391 and 4,401,456, that issued Aug. 23, 1983 and Aug. 30, 1983, respectively, disclose the use of alginate gel beads to encapsulate bioactive materials to provide for their controlled release. These patents describe beads that are made to either float or sink and they can contain insecticides. These beads are also described as acting as a carrier to place the bioactive material near the target species, for example, a floating bed of beads containing a herbicide, and releasing the herbicide from the beads in close proximity to floating aquatic weeds. It also contemplates the beads capable of falling through foliage to eventually release herbicide into the soil.

U.S. Pat. No. 4,344,857 that issued on Aug. 17, 1982 contains a disclosure that is similar to those described Supra, in that they involve encapsulation by xanthate derivatives and do not disclose the ability to be used in conjunction with an aqueous environment. A number of patents describe the use of substances other than Pesticides to control the growth of insects. U.S. Pat. No. 4,053,627 that issued Oct. 11, 1977 discloses a controlled release system for the use of juvenile hormones in aqueous environments. This is described in the patent as being accomplished with alginate gel discs comprising: alginate, a solubilizing agent, and a salt that yields cations, and also contains the juvenile hormone.

U.S. Pat. No. 4,160,033 that issued on Jul. 3, 1979 discloses a method for the control of mosquitoes by the use of film-forming materials. The method is disclosed as involving the use of a film of organic material that reduces the surface tension of the body of water being treated, and subsequently causes the mosquito larvae and pupae to drown.

### BRIEF DESCRIPTION OF THE DRAWINGS

FIG. 1 is a graph showing the effects of the use of a solution of 5 weight percent of copper sulphate pentahydrate in 95 weight percent inert carriers in the treatment of Anopheles mosquitoes in example 1.

FIG. 2 is a graph showing a first control for example 1.

FIG. 3 is a graph showing a second control for example 2.

FIG. 4 is the treatment with 0.25 ppm copper and Kathon®, a quaternary ammonium salt.

FIG. 5 is the treatment with 0.25 ppm copper and sodium dodecyl sulphate.

FIG. 6 is a graph showing the results of example

FIG. 7 is the key for FIG. 6 wherein (LB) is live bacteria; LS is Unformulated composition, and CuSO₄ is CuSO₄ pentahydrate in water at 5%.

FIG. 8 is a graph showing the results of example

FIG. 9 is the key for FIG. 8 wherein ET is Unformulated composition.

### THE INVENTION

This invention deals with Formulated and Unformulated Cidal compositions comprised, in one embodiment, of a metal compound, a detergent, and an inert carrier for the metal compound and to methods for their use. Especially preferred are heavy metals.

### DETAILED DESCRIPTION OF THE INVENTION

The invention described and claimed herein in one embodiment comprises a Formulated Cidal composition comprising a metal compound, a detergent, and an inert carrier.

The metal compound can be selected from a group that includes, for example, copper, iron, chromium, manganese, cobalt, platinum, zinc, mercury, tin, lead, magnesium, barium, titanium vanadium, nickel, cadmium, gold, aluminum, bismuth, molybdenum, selenium, rhodium, antimony, arsenic, tungsten, scandium, and the like, and preferably consists of copper, iron, chromium, manganese, zinc, mercury, tin, lead, magnesium, barium, titanium, nickel, gold, tungsten, arsenic, antimony, aluminum, bismuth, molybdenum, and selenium and most preferably consists of copper, iron, manganese, cobalt, zinc, mercury, tin, lead and nickel.

It is known that metal compounds are Cidal in nature in quantities that have high concentrations of the metal. It has also been discovered that if these compounds were used, they caused tox problems for humans, for example in the treatment of drinking water and thus, such compounds have not been used because it was thought that higher quantities of the compounds were necessary in order to have the necessary Cidal effect on Pests.

The inventors herein have found that such materials can be used in very low concentrations in aqueous media and still have the required Cidal effect. Thus, such compounds, by law, cannot be used in quantities greater than about 1.3 parts per million, that is, the amount of metal in the system has to have an Effigy of less than 1.3 parts per million in order to be useful, and amounts greater than this cannot be legally used. This requirement has created a very limited use for the metal compounds.

A second component of the composition is a detergent. The detergent is used in the range of from 0.01% by weight to 0.1% by weight based on the total amount of metal compound, detergent, and inert ingredients in the composition.

The type of detergent is not critical in this invention and useful detergents can be for example, sodium alkyl sulfates, such as sodium dodecyl sulfate, octylphenol ethoxylates, such as Triton X, manufactured by the Dow Chemical Company, Midland, Mich., and quaternary ammonium salts, such as Kathon® and Kathamin®, sold by the Rohm and Hass Company, Philadelphia, Pa., and the like.

The third component of the composition consists of materials that are intended as inert ingredients to act as carriers for the products wherein the inert ingredients may or may not enhance certain properties of the Cidal compositions.

Another embodiment of this invention is a method of using an Unformulated Cidal composition wherein the method comprises contacting an aqueous body with at least a total amount effective to control any population of Pest contaminants in the aqueous body, of the Unformulated Cidal composition, and allowing the Unformulated Cidal composition to remain in contact with the aqueous body and the population of Pest contaminants. The Cidal composition is a metal compound in an inert carrier for the metal compound, and the amount of metal in the Unformulated Cidal composition has an Effigy of 1.3 parts per million or less in use.

There is yet another method of using a Unformulated Cidal composition wherein the method comprises contacting an area occasionally containing aqueous bodies of water with an amount of Unformulated Cidal composition. and allowing the Unformulated Cidal composition to remain in place on the area until the area is contacted with water and thereafter, allowing the composition to remain in contact with the aqueous body wherein the Cidal composition is a metal compound in an inert carrier for the metal compound, and the amount of metal in the Unformulated Cidal composition has an Effigy of 1.3 parts per million or less in use

There is yet another embodiment of this invention which is a method of controlling Pests in an aquatic environment. The method comprises determining the average count of Pests or Pest contaminants in the aquatic environment and contacting said aquatic environment with an amount of Unformulated Cidal composition and allowing the Unformulated Cidal composition to remain in place in the aquatic environment. The Cidal composition is a metal compound in an inert carrier for the metal compound, and the amount of metal in the Unformulated Cidal composition has an Effigy of 1.3 parts per million or less in use.

Turning to another embodiment of this invention there is a method of controlling Pests by contacting a solid substrate with a Unformulated Cidal composition and allowing the Unformulated Cidal composition to remain in contact with the solid substrate. The Cidal composition is a metal compound in an inert carrier for the metal compound, and the amount of metal in the Unformulated Cidal composition has an Effigy of 1.3 parts per million or less in use.

A further embodiment of this invention is a method of using a Formulated Cidal composition comprised of a metal compound, an inert carrier for the metal compound and a detergent. The method comprises contacting an aqueous body with at least a total amount effective to control any population of Pest contaminants in the aqueous body, of the Formulated Cidal composition, and allowing the Formulated Cidal composition to remain in contact with the aqueous body and the population of Pest contaminants. The amount of metal in the Formulated Cidal composition has an Effigy of 1.3 parts per million or less in use.

Yet another embodiment of this invention is a method of using a Formulated Cidal composition comprised of a metal compound, an inert carrier for the metal compound and a detergent. The method comprises contacting an area occasionally containing aqueous bodies of water with an amount of Formulated Cidal composition, and allowing the Formulated Cidal composition to remain in place on the area until the area is contacted with water and thereafter, allowing the composition to remain in contact with the aqueous body wherein the amount of metal in the Formulated Cidal composition has an Effigy of 1.3 parts per million or less in use.

Still another embodiment of this invention is a method of controlling Pests in an aquatic environment. The method comprises determining the average count of Pests or Pest contaminants in the aquatic environment and contacting said aquatic environment with an amount of Formulated Cidal composition comprising a metal compound, an inert carrier for the metal compound and a detergent, and allowing the Formulated Cidal composition to remain in place in the aquatic environment, wherein the amount of metal in the Formulated Cidal composition has an Effigy of 1.3 parts per million or less in use.

There is a final embodiment of this invention that is a method of controlling Pests by contacting a solid substrate with a Formulated Cidal composition comprised of a metal compound, an inert carrier for the metal compound, and a detergent, and allowing the Formulated Cidal composition to remain in contact with the solid substrate wherein the amount of metal in the Formulated Cidal composition has an Effigy of 1.3 parts per million or less in use.

The Formulated Cidal compositions of this invention are easily prepared by simply mixing the materials together.

Prior to the 1950's, malarial control programs focused on killing mosquito larvae primarily through the application of copper salts and reducing the breeding habitat of mosquitoes near human populations. These programs were successful and suppressed or eradicated malaria from vast areas of Europe, Asia and the Americas. With the advent of DDT and similar Pesticides, the malaria-control strategies based on larvicides were chiefly abandoned, neglected or marginalized in favor of programs that rely almost exclusively on extermination of adult mosquitoes with synthetic Pesticides (adulticiding processes). While the development of advanced approaches to malaria control, such as transmission-blocking vaccines and genetically modified mosquitoes are being vigorously advocated and pursued, these methods may not bear fruit for several years and their likelihood of success has been questioned. Despite millions of dollars in research and decades of intensive infection control efforts with active detection, drug treatment and domestic insecticidal spraying, malaria remains robust across most tropical regions in sub-Saharan Africa. Larval control, which was so successful in Europe, Asia and the Americas has long been undervalued and underused in Africa.

### EXAMPLES

### Example 1

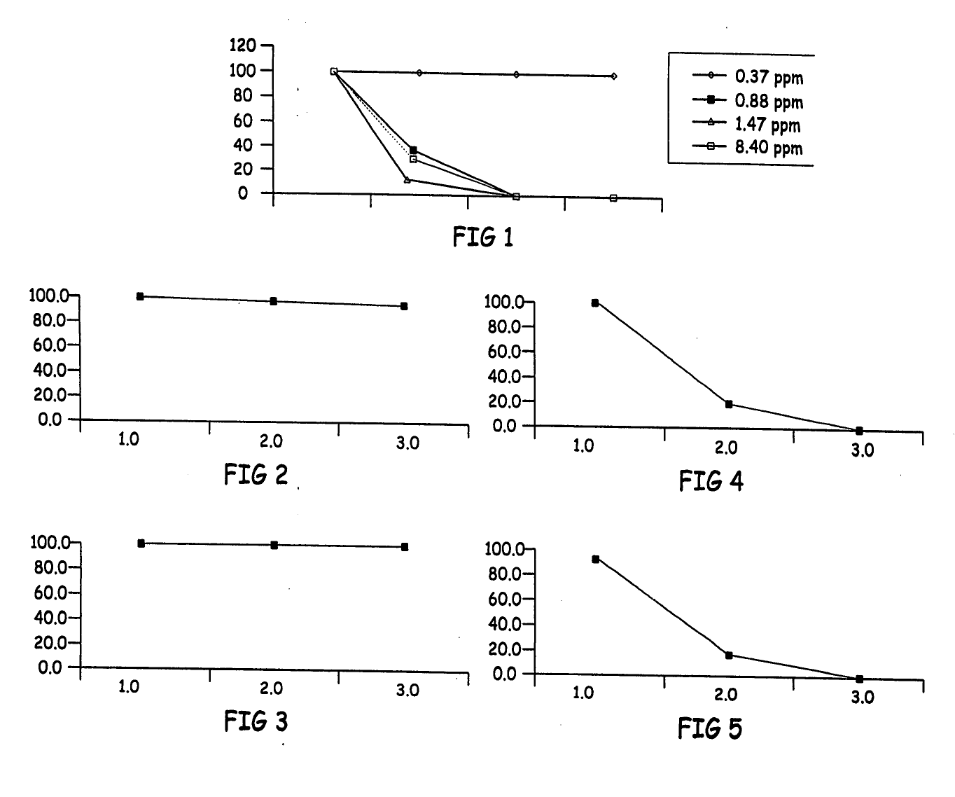

A solution in water of copper sulphate pentahydrate at 5 weight percent was used to treat Anopheles mosquitoes. The mosquitoes were wild caught and they were not separated by larval stage so there is some variability in the response to the test. The data is based upon 1000 larvae per treatment. Amounts of copper were used at 0.37 ppm, 0.88 ppm, 1.47 ppm, and 8.4 ppm. It can be noted that all larvae receiving more than 0.8 ppm of the copper died by day 3 and at 0.37 ppm, survivorship was nearly 100%. See FIG. 1. The Y-axis is the percentage of survivorship and the X-axis is the number of days of exposure. It is not known in this experiment whether the kill rate at the higher concentrations is due to the higher concentration of copper, or due to the more acid pH provided by the copper sulphate.

The tests were repeated wherein a copper compound in inert carrier was treated with a detergent as an additive to determine if the additive increased the efficacy of the copper. The treatment was at 0.25 ppm copper as the metal, well below the no-effect dose from the first part of this experiment of 0.37 ppm. The first control is FIG. 2, Stage 1 larvae, the duplicate control, Stage 1 larvae, is FIG. 3 wherein, in both Figures, the Y-axis is the percentage of survivorship and the X-axis is the number of days of exposure.

FIG. 4 is the results of a treatment of Anopheles mosquitoes, Stage 1 larvae, using copper at 0.25 ppm as a 5% volume solution, wherein the additive is Kathon ®, a quaternary ammonium salt. Kathon was added at 0.02 weight percent. As shown, by day 2, over 80% of the mosquitoes were dead and at day 3, 100% of the mosquitoes were dead. The Y-axis is the percentage of survivorship and the X-axis is the number of days of exposure.

Treating Stage 1 larvae, a second additive used was sodium dodecyl sulphate along with the copper sulphate in an inert carrier, and the results are shown on FIG. 5. The copper was used at the 0.25 ppm level. By day 2, over 80% of the mosquitoes were dead and by day 3, 100% of the mosquitoes were dead. The Y-axis is the percentage of survivorship and the X-axis is the number of days of exposure.

### Example 2

Three different types of experiments were conducted in order to assess the efficacy of an inventive solution on E. Coli bacteria and fungi.

1. The Unformulated composition containing 5 weight percent of copper sulphate in an inert carrier was added directly to growth media, namely, Agar, in order to evaluate it's efficacy as a disinfectant.
2. The same solution was added to bacteria and its growth was monitored by optical density readings as a function of time.
3. The same solution alone or in combination with a detergent was added to bacteria or fungi and incubated for 10 minutes or 60 minutes and the incubation mix was plated on to agar growth media in order to estimate survival.

Results:

a. The Unformulated composition at different concentrations was added to live bacterial agar media and the agar plates were exposed to the atmosphere by keeping the Petri plates open to the atmosphere for 6 hours. By doing this it was expected to allow aerial bacteria to grow in the plates.

Control plates without the Unformulated composition contained confluent colonies of bacteria (infinite) and fungi. Plates with the Unformulated composition at 0.015 weight percent (0.3 ml of the Unformulated composition added to 99.7 ml of Live Bacteria media) contained no bacteria or fungi. This indicated that the Unformulated solution had the capacity to sanitize the growth media. Plates with copper sulphate at 5% allowed no fungal growth but allowed bacterial growth.

b. Bacteria were grown to log phase and bacteria at an optical density 600 of 0.028 was added to the Unformulated composition or Matrix of different concentrations. The change in optical density which is a reflection of bacterial growth was measure at different time period using a spectrophotometer where the determination is the amount of light absorbed by a suspension of the bacterial cells wherein the average is 380 to 780 and 600 was used herein.

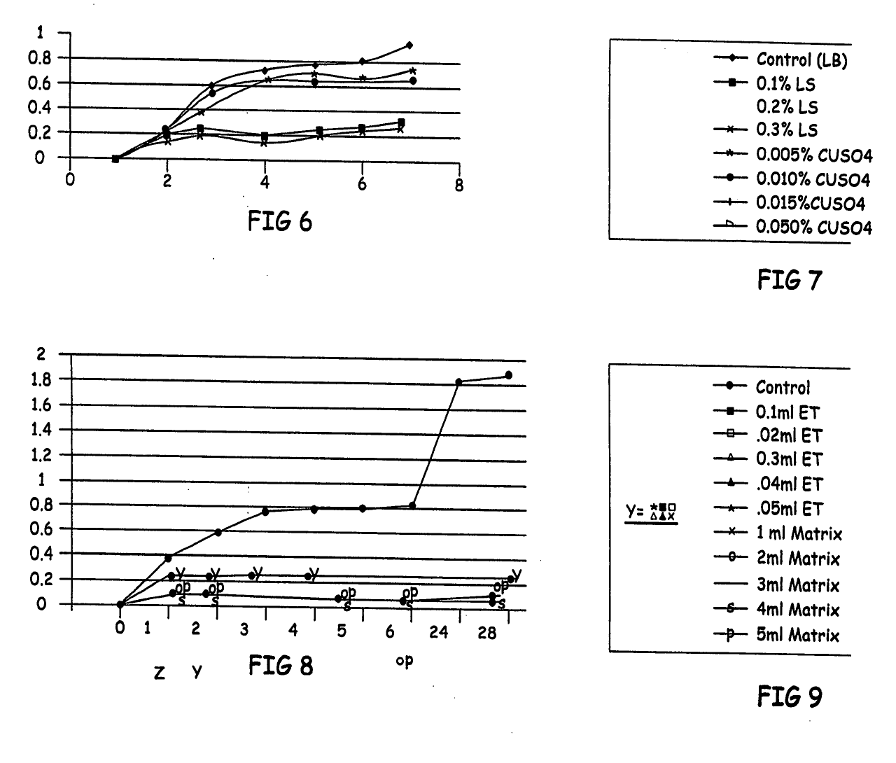

Both Matrix and the Unformulated compositions controlled the bacterial growth. However, this type of experiment, eventhough it does not discriminate very well between dead and living cells, is a definite indicator of bacterial multiplication. The results are shown in FIG. 6 and FIG. 7. Both the matrix and the Unformulated composition controlled growth even at a concentration of 0.005%.

c. Bacteria with the Unformulated composition was incubated for 10 minutes or 60 minutes before plating them. At 10 minutes, the Unformulated composition killed the bacteria at a concentration of 0.25% and when exposed for 60 minutes, it killed bacteria at a concentration of 0.015% indicating that a higher incubation time was necessary for killing bacteria if low concentrations of the Unformulated composition was used. See FIGS. 8 and 9. Because of the closeness of the data points, the inventors herein would point out that the top line is the control, the next set of lines lower are constituted of 0.1, 0.2, 0.3, 0.4, 0.5 of ET and 1 ml Matrix, while the bottom set of lines are constituted of 2 ml Matrix, 3 ml Matrix, 3 ml Matrix, 4 ml Matrix, and 5 ml of Matrix.

4. The effect of adding detergents, that is, sodium dodecyl sulfate to the Unformulated composition.

The Unformulated composition at 0.005% supplemented with 0.02% sodium dodecyl sulfate completely prevented bacterial growth after exposing the bacteria for 10 minutes. The detergent alone allowed growth up to a concentration of 0.2%. Thus, the addition of the detergent potentiated the antibacterial effects of the Unformulated composition since bacteria were disinfected at a much lower concentration of the Unformulated composition that when the Unformulated composition was used alone. In the case of fungi, a concentration of the Unformulated composition at 0.05% supplemented with 0.02% detergent was sufficient to kill fungi when the incubation period was 10 minutes.

Thus, the studies show that Unformulated composition at 0.005% supplemented with 0.02% sodium dodecyl sulphate will disinfect bacteria after a 10 minute exposure. In the case of the fungi, the antifungal disinfectant effect was seen at a concentration of 0.05% Unformulated composition supplemented with 0.02% sodium dodecyl sulphate.

1. (canceled)

2. (canceled)

3. (canceled)

4. (canceled)

5. (canceled)

6. (canceled)

7. (canceled)

8. A method of using an Unformulated Cidal composition, said
method comprising contacting an aqueous body with at least a total amount effective to control any population of Pest contaminants in the aqueous body, of the Unformulated Cidal composition, and allowing the Unformulated Cidal composition to remain in contact with the aqueous body and the population of Pest contaminants, wherein the Cidal composition is a metal compound in an inert carrier for the metal compound, and the amount of metal in the Unformulated Cidal composition has an Effigy of 1.3 parts per million or less.

9. A method of using a Unformulated Cidal composition, said method comprising contacting an area occasionally containing aqueous bodies of water with an amount of UnFormulated Cidal composition, and allowing the UnFormulated Cidal composition to remain in place on the area until the area is contacted with water and thereafter, allowing the composition to remain in contact with the aqueous body wherein the Cidal composition is a metal compound in an inert carrier for the metal compound, and the amount of metal in the Unformulated Cidal composition has an Effigy of 1.3 parts per million or less.

10. A method of controlling Pests in an aquatic environment, the method comprising determining the average count of Pests or Pest contaminants in the aquatic environment and contacting said aquatic environment with an amount of Unformulated Cidal composition and allowing the Unformulated Cidal composition to remain in place in the aquatic environment, wherein the Cidal composition is a metal compound in an inert carrier for the metal compound, and the amount of metal in the Unformulated Cidal composition has an Effigy of 1.3 parts per million or less.

11. A method of controlling Pests by contacting a solid substrate with a Unformulated Cidal composition and allowing the Unformulated Cidal composition to remain in contact with the solid substrate wherein the Cidal composition is a metal compound in an inert carrier for the metal compound, and the amount of metal in the Unformulated Cidal composition has an Effigy of 1.3 parts per million or less.

12. A method of using a Formulated Cidal composition as claimed in claim 1, said method comprising contacting an aqueous body with at least a total amount effective to control any population of Pest contaminants in the aqueous body, of the Formulated Cidal composition, and allowing the Formulated Cidal composition to remain in contact with the aqueous body and the population of Pest contaminants, and wherein the amount of metal in the Formulated Cidal composition has an Effigy of 1.3 parts per million or less.

13. A method of using a Formulated Cidal composition as claimed in claim 1, said method comprising contacting an area occasionally containing aqueous bodies of water with an amount of Formulated Cidal composition, and allowing the Formulated Cidal composition to remain in place on the area until the area is contacted with water and thereafter, allowing the composition to remain in contact with the aqueous body wherein the amount of metal in the Formulated Cidal composition has an Effigy of 1.3 parts per million or less.

14. A method of controlling Pests in an aquatic environment, the method comprising determining the average count of Pests or Pest contaminants in the aquatic environment and contacting said aquatic environment with an amount of Formulated Cidal composition as claimed in claim 1 and allowing the Formulated Cidal composition to remain in place in the aquatic environment, wherein the amount of metal in the Formulated Cidal composition has an Effigy of 1.3 parts per million or less.

15. A method of controlling Pests by contacting a solid substrate with a Formulated Cidal composition as claimed in claim 1 and allowing the Formulated Cidal composition to remain in contact with the solid substrate wherein the amount of metal in the Formulated Cidal composition has an Effigy of 1.3 parts per million or less.

16. A Cidal composition comprising:
A) a combination of at least two metal compounds,
(B) an inert carrier for the metal compounds and,
(C) a detergent, wherein the detergent is present at 0.01 to 0.1 weight percent based on the total weight of (A), (B), and (C).

17. A Cidal composition comprising:
(A) a combination of at least two metal compounds,
(B) an inert carrier for the metal compounds and,
(C) a combination of at least two detergents, wherein the detergents are present in combination at 0.01 to 0.1 weight percent based on the total weight of (A), (B), and (C).

18. A Cidal composition comprising:
(A) a combination of at least two metal compounds,
(B) an inert carrier for the metal compounds and,
(C) a combination of at least two detergents, wherein the detergents are present in combination at 0.01 to 0.1 weight percent.

19. A Cidal composition comprising at least two metal compounds in combination in an inert carrier.
